(19) United States
(12) Patent Application Publication
(10) Pub. No.: US 2026/0316786 A1
(43) Pub. Date: Oct. 15, 2026

(54) SYSTEM AND METHOD FOR AUTOMATICALLY ADAPTING A SPEED OF A MOTOR VEHICLE THAT IS OPERATED BY MEANS OF AN AUTOMATED DRIVING SYSTEM

(71) Applicants: HYUNDAI MOTOR COMPANY, Seoul (KR); KIA CORPORATION, Seoul (KR)

(72) Inventors: Thomas SCHRAMM, Ruesselsheim (DE); Jendrik HOGREFE, Ruesselsheim (DE); Ansgar POTT, Ruesselsheim (DE); Jens SCHENKENBERGER, Ruesselsheim (DE)

(73) Assignees: HYUNDAI MOTOR COMPANY, Seoul (KR); KIA CORPORATION, Seoul (KR)

(21) Appl. No.: 19/535,508

(22) Filed: Feb. 10, 2026

(30) Foreign Application Priority Data
Apr. 14, 2025 (DE) 102025114509.1

(51) Int. Cl. B60W 60/00; B60W 30/14

(52) U.S. Cl. CPC B60W 60/0013; B60W 30/143; B60W 2420/403; B60W 2540/01; B60W 2540/21; B60W 2540/22; B60W 2540/221; B60W 2720/106

(57) ABSTRACT

A system for automatically adapting a speed of a motor vehicle which is operated by an automated driving system, includes an automated driving system, which is configured to control a speed of a motor vehicle, wherein at least one vehicle occupant sits in the motor vehicle; and a microphone unit detecting a conversation inside the motor vehicle based on an indicator for the conversation, wherein the indicator includes a voice of the at least one vehicle occupant, wherein the automated driving system is further configured to automatically adapt a speed of the motor vehicle depending on the indicator for the conversation. Furthermore, various embodiments of the present disclosure relates to a motor vehicle with such a system and to a method for automatically adapting a speed of a motor vehicle which is operated by an automated driving system.

### CROSS-REFERENCE TO RELATED APPLICATION

The present application claims priority to and the benefit of German Patent Application No. 102025114509.1, filed on Apr. 14, 2025, the present disclosure of which is incorporated herein by reference in its entirety.

### Field of the Present Disclosure

The present disclosure pertains to a system for automatically adapting a speed of a motor vehicle which is operated by an automated driving system, a motor vehicle and a method for automatically adapting a speed of a motor vehicle which is operated by an automated driving system.

### Background

Automated Driving Systems (ADS) have become more prevalent in recent years. Such systems are broadly classified into 5 levels defined by the SAE J3016 standards, with levels, one and two relating to more basic driver assistance and partial automation functions, and higher levels, three to five relating to more advanced functionality where, at least under certain circumstances, the human driver no longer has to actively monitor the driving environment.

Level one and two systems are often referred to as Advanced Driver Assistance Systems (ADAS). In these cases, the driver is required to maintain awareness and be prepared to intervene immediately in the event that the ADAS is unable to respond appropriately to a driving situation. Accordingly, in an ADAS operating at level one or two, the system will monitor driver awareness and provide a warning to the driver as soon as a lack of awareness is detected. For example, an automatic lane keeping system will issue an alert to the driver if their hands stray from the wheel for more than a predetermined time, for instance, by outputting an audible alarm and vibrating their seat.

Although providing an alert to the driver has been sufficient to meet formal and legal requirements for such systems, the present warning functionality does not guarantee safety in practice. For example, a driver who has momentarily fallen asleep will not regain complete situational awareness immediately when they are woken by an alert. Accordingly, there may be a delay in their ability to respond rapidly if the ADAS is unable to handle the current driving situation. Indeed, a driver who is suddenly startled awake may even take erratic actions in the moments before their situational awareness is fully restored.

The above issue remains important as more advanced level 3 systems become available. In the instant case, automation is conditional and hence a driver may still be asked to retake control within a limited time if driving conditions change. Such vehicles controlled by an Automated Driving System are able to adapt their driving speed e.g., to surrounding obstacles, the presence of other vehicles, road curvature and speed limits. Interior noises result from a composition of different noise natures, such as wind noise, engine noise, and rolling noise. There are different noise source contributions to vehicle environments and they can be separated into many different aspects. For example, vehicle interior noise can be focused on vehicle subsystems and components, such as tire-road interaction noise or aerodynamic noise. It is known in the art that the vehicle speed is strongly correlated to interior noise levels, suggesting the most relevant noise sources are in the vehicle itself.

For example, document WO 2021/244826 A1 describes a method for controlling the sound volume generated by a loudspeaker (HP) in a booth.

Document JP 2019- 137167 A describes a sound output control device that can control a sound volume output from a sound generation device at the time when an occupant starts speaking, wherein the audio output control device is based on an image acquisition unit that obtains an image captured by an imaging device that captures the face of an occupant riding in a vehicle.

### BRIEF SUMMARY

Hence, there is a need to find solutions for reducing the interior noise in case a conversation is taking place within the motor vehicle.

To the present end, various aspects of the present disclosure are directed to providing a system in accordance with claim 1, a motor vehicle in accordance with claim 7 and a method in accordance with claim 8.

According to various aspects of the present disclosure, a system for automatically adapting a speed of a motor vehicle which is operated by an automated driving system is disposed. The system includes an automated driving system, which is configured to control a speed of the motor vehicle. At least one vehicle occupant sits in the motor vehicle. Furthermore, the system includes a microphone unit detecting a conversation inside the motor vehicle based on an indicator for the conversation. The indicator includes a voice of the at least one vehicle occupant. The automated driving system is further configured to automatically adapt a speed of the motor vehicle depending on the indicator for the conversation.

According to various aspects of the present disclosure, a motor vehicle with a system according to the first aspect of the present disclosure is provided.

According to various aspects of the present disclosure, a method for automatically adapting a speed of a motor vehicle which is operated by an automated driving system is provided. The method includes a step of operating a motor vehicle by an automated driving system, which is configured to control a speed of the motor vehicle, wherein at least one vehicle occupant sits in the motor vehicle. The method further includes a step of detecting a conversation inside the motor vehicle based on an indicator for the conversation, wherein the indicator includes a voice of the at least one vehicle occupant. Moreover, the method includes a step of automatically adapting a speed of the motor vehicle by the automated driving system depending on the indicator for the conversation. A method for automatically adapting a speed of a motor vehicle which is operated by an automated driving system by use of a system according to the first aspect of the present disclosure is provided.

One idea of the present disclosure is that in case of a conversation taking place in the motor vehicle, drivers and/or passengers may wish for a reduced interior noise. Therefore, a limitation of the speed i.e., driving speed may be an adequate measure to reduce the interior noise. Thus, the speed of the motor vehicle controlled by the Automated Driving System may be reduced. The automated driving system is configured to control an automated driving vehicle providing a driverless transportation service to a user. Typically, the automated driving system is disposed on the automated driving vehicle. Alternatively, at least a portion of the automated driving system may be disposed outside the automated driving vehicle and remotely control the automated driving vehicle. The conversation may be taking place within the passenger compartment or over the phone. In other words, various aspects of the present disclosure are directed to providing an adaption of the speed of the motor vehicle controlled by the Automated Driving System in respect to a detected conversation in the motor vehicle. A minimum speed i.e., threshold from which on an adaption, in particular a reduction, of the speed may be carried out may be set by traffic rules.

If the indicator is triggered the conversation is detected. If the conversation is detected the automatically adapting of the speed is carried out. of course, the speed shall only be reduced if no pertinent traffic rules prohibit to drive slower, e.g., in case of a minimum speed on a respective driving lane, or be increased if no pertinent traffic rules prohibit to drive faster.

Hence, the present disclosure can solve the source for the at least one vehicle occupant, i.e., the driver and/or passenger potentially speaking louder than normal. A result of applying the present disclosure may be a less stressful conversation of the vehicle occupants leading to a higher user experience. With the driving speed linked to interior noise, the exemplary speed may be subject to the conversation taking place.

With a reduction of the interior noise, the driver and the passengers are able to communicate easier. Moreover, with the present disclosure the user is more likely to use an Automated Driving System and not to drive manually since the vehicle can adapt more to the user’s needs.

The present disclosure is relevant to vehicles, including cars, with advanced driver assistance systems and autonomous driving capabilities.

No new or additional hardware is required when applying the system and/or method according to various aspects of the present disclosure, in particular if the vehicle is disposed with an internal microphone. The present disclosure can use existing equipment of the motor vehicle. Consequently, the present disclosure does not have any influence on a package of the vehicle, and therefore, saves cabin space. Furthermore, lower total costs of ownership (TCO) may be provided by the present disclosure.

A further advantage of the present disclosure is that the method is a fully automatic process. Hence, the method may be also applicable to new mobility services, PBVs and robotaxis.

It is understood that the term “vehicle” or “vehicular” or other similar term as used herein is inclusive of motor vehicles in general such as passenger automobiles including sports utility vehicles (SUV), buses, trucks, various commercial vehicles, and the like, and includes hybrid vehicles, electric vehicles, plug-in hybrid electric vehicles, hydrogen-powered vehicles and other alternative fuel vehicles (e.g., fuels derived from resources other than petroleum). As referred to herein, a hybrid vehicle is a vehicle that has two or more sources of power, for example both gasoline-powered and electric-powered vehicles.

The motor vehicle in the meaning of the present application may include a two-wheeler like a bicycle, a vehicle, a truck or similar.

Advantageous embodiments and improvements of the present disclosure are found in the subordinate claims.

According to various aspects of the present disclosure, the system further includes a seat occupancy detection device which is configured to detect a presence of at least another vehicle occupant. For example, the indicator may be triggered by the seat occupancy detection device when at least another vehicle occupant is present in a second seat row or in a third seat row or in both.

According to various aspects of the present disclosure, the system further includes a camera unit which is configured to detect a presence of at least another vehicle occupant. Hence, the camera unit can determine where the at least another vehicle occupant sits in the motor vehicle and/or who in the motor vehicle is talking. Furthermore, the camera unit may be configured to determine a facial feature of the at least one vehicle occupant. Thus, an emotion analysis of the conversation may be carried out by the camera unit, wherein the emotion analysis is based on the facial feature of the at least one vehicle occupant.

According to various aspects of the present disclosure, the system further includes a speech recognition device which is configured to detect a frequency of asking back between the at least one vehicle occupant. The speech recognition device can further be configured to detect the conversation of at least two vehicle occupants that are talking and sitting in different seat rows with respect to each other.

According to various aspects of the present disclosure, the automated driving system is further configured to limit an acceleration of the motor vehicle. Hence, a noise generated by the propulsion system of the motor vehicle may be reduced during an acceleration process of the motor vehicle. The noise may be reduced when the propulsion system is configured as an internal combustion engine. The acceleration may be limited to a range below about 2 m/s² or less.

According to various aspects of the present disclosure, the system further includes an audio-video-navigation system which is configured to adjust a duration of the conversation, a speed change, a maximum for the acceleration and/or a minimum speed. The duration of the conversation of the at least one vehicle occupant as a trigger for detecting the conversation may be adjusted by the at least one vehicle occupant. Furthermore, the speed change i.e., the magnitude of decrease or increase in speed may be adjusted by the at least one vehicle occupant. Alternatively or additionally, the maximum for the acceleration may be adjusted by the at least one vehicle occupant. Moreover, the minimum speed from which on an adaption, in particular a reduction, of the speed may be carried out may be adjusted by the at least one vehicle occupant. Nevertheless, the minimum speed i.e., the threshold may be set by traffic rules and/or user settings. Furthermore, the at least one vehicle occupant may be able to abort a begun speed decrease e.g., by pressing a button of audio-video-navigation system of the motor vehicle.

Optionally, the system may further include a non-transitory computer-readable storage medium which is in communication with the automated driving system, wherein the storage medium is configured to store a reference value for a volume of the voice of the at least one vehicle occupant, for a facial feature of the at least one vehicle occupant, for a heartrate variability and/or for a skin conductance of the at least one vehicle occupant.

According to various aspects of the present disclosure, the speed is adapted corresponding to a predetermined range of a speed change, to a predetermined range of a percentage value and/or to a reduction of an interior noise in the motor vehicle. Since tyre stimulation is a contributing factor to the development of interior noise in the motor vehicle which adapts, in particular reduces, the speed corresponding to the predetermined range of the speed change i.e., the magnitude of decrease or increase in speed or corresponding to the predetermined range of the percentage value or both can reduce the interior noise. For example, the predetermined range of the speed change may be of about 20 km/h or less, in particular in the range from about 5 km/h to about 20 km/h. For example, the predetermined range of the percentage value may be in the range from about 10 % to about 20 %. The reduction of the interior noise could be in the range from about 3 dB to about 8 dB.

For example, the interior noise in the motor vehicle may be reduced by increasing the speed so that a stimulating frequency has a greater distance with regard to the eigenfrequency of the motor vehicle. Alternatively or additionally, the interior noise in the motor vehicle may be reduced by increasing the speed and selecting a higher gear so that a resulting engine speed is lower. In both before mentioned cases, the speed may be increased slightly, in particular up to a speed change of about 10 km/h or less. The percentage value can incorporate environmental conditions, for example a current road class, weather conditions, or similar.

Optionally, a change of driving lane may lead to a reduction of the interior noise depending on the road surface. Thus, if permitted by driving rules, the motor vehicle can change the driving lane. If the interior noise is lower than on the original driving lane, the motor vehicle may stay on the new driving lane.

According to various aspects of the present disclosure, the indicator includes a presence of at least another vehicle occupant, a volume of the voice of the at least one vehicle occupant, a facial feature of the at least one vehicle occupant, a duration of the conversation of the at least one vehicle occupant and/or a frequency of asking back between the at least one vehicle occupant. For example, the indicator may be triggered when at least another vehicle occupant is present in a second seat row or in a third seat row or in both. The frequency of asking back may be detected by a speech recognition device which is disposed in the motor vehicle.

According to various aspects of the present disclosure, the duration of the conversation exceeds a value in the range from about 1 minute to about 3 minutes. Hence, short periods of talking does not result in automatically adapting the speed. Furthermore, several changes of the speed in a few minutes may be prevented and improve a comfort of driving. Alternatively or additionally, the duration of the conversation can exceed a predetermined quotient of speech and pause.

According to various aspects of the present disclosure, the conversation includes at least two vehicle occupants that are talking and sitting in different seat rows with respect to each other.

According to various aspects of the present disclosure, the indicator is further configured to determine if the detected speech in the conversation corresponds to a radio broadcast content. In case the detected speech includes the radio broadcast content the indicator is not triggered. Thus, the conversation is not detected when the detected speech includes the radio broadcast content.

According to various aspects of the present disclosure, the automatically adapting of the speed includes limiting an acceleration of the motor vehicle. Hence, a noise generated by the propulsion system of the motor vehicle may be reduced during an acceleration process of the motor vehicle. the noise may be reduced when the propulsion system is configured as an internal combustion engine. The acceleration may be limited to a range below about 2 m/s² or less.

According to various aspects of the present disclosure, the method further includes a step of detecting a volume of the conversation after the automatically adapting of the speed, wherein the volume of the conversation after the automatically adapting of the speed is compared to a volume of the conversation before the automatically adapting of the speed, wherein based on the comparison of both the volumes the automatically adapting of the speed is repeated. Accordingly, the automatically adapting of the speed does not have to be repeated identically, but it can also adapt the speed in a different way than before. After adapting the speed, it may be detected if the volume of the conversation, so of the at least one speaking vehicle occupant, is reduced or not. In case a reduction of the volume of the at least one speaking vehicle occupant is deemed as being not sufficient, a further step of automatically adapting the speed, in particular a further reduction of the speed, may be carried out.

Optionally, a signal to noise ratio (SNR) calculation may be performed for detecting if the interior noise is the reason for speaking loud. If a difference in the volume between the conversation volume and the interior noise stays unchanged even if the interior noise level decreases, e.g., due to the lower speed, it may be assumed that the vehicle occupant who talks wants to speak loud.

According to various aspects of the present disclosure, the indicator further includes an emotion analysis of the conversation, wherein the emotion analysis is based on a feature amount of the voice, on facial feature of the at least one vehicle occupant, on a heartrate variability and/or on a skin conductance of the at least one vehicle occupant. In other words, the indicator is further configured to determine an arousal level of the conversation. If the emotion analysis reveals that the at least one vehicle occupant has a high arousal level, in particular a higher arousal level than usually, it may be assumed that this is the reason for speaking loud and not a high interior noise level.

For example, a voice acquisition unit can obtain voice data from the at least one vehicle occupant who talks. An emotion analysis unit can divide the voice data obtained by the voice acquisition unit into predetermined periods, and quantifies the user's emotions based on, for example, the feature amount of the voice in the predetermined period. The predetermined time period is, for example, a period of talking in one breath, that is, a period from one breath to the next, and this is defined as one sentence. Not limited to this, the predetermined time period may be a predetermined cycle, a predetermined number of measures, or a series of words divided by punctuation marks when the lyrics are parsed. The feature amount of the voice may be at least one of the pitch of the sound contained in the voice, the strength of the sound, the intonation of the spoken word, and the speed of utterance of the word, or the amount of change of at least one of the words.

Furthermore, the emotion analysis unit may be based on the result of quantifying emotions in each of the predetermined periods forming the voice data related to the conversation. The emotional state or the transition of the state is obtained, and the emotion of the conversation may be evaluated. The emotion is, for example, at least one of joy, normality (calmness), sadness, anger, and energy. Furthermore, the evaluation is, for example, a magnitude relationship of the emotions quantified in the conversation.

To analyze emotions, various voice data are reproduced in advance, and what kind of emotions the person who hears them expresses may be evaluated. For example, evaluate what kind of emotion each voice data expresses, such as feeling angry, feeling calm (normal), feeling sad, feeling happy, feeling fine, etc. Each voice data is tagged with joy, normality, sadness, anger, energy, etc. The tagged voice data may be stored in a storage unit as reference data. Accordingly, the voice data of the conversation may be compared with the reference data, and the pitch and strength of the sound may be compared. Accordingly, reference data similar to the voice data of the conversation may be obtained for features such as intonation of the spoken word and the speed of speech of the word, and the type of emotion is determined by the tags attached to the similar reference data. Quantify the magnitude of emotions by the number of similar reference data. For example, among similar reference data, if the number of data tagged with anger is large, it may be evaluated that anger is large, and if the number of similar reference data tagged with anger is small, it may be evaluated that sadness is small.

Quantifying emotions is not limited to this, and other methods may be used. For example, machine learning (deep learning) may be performed using the above reference data as teacher data, and correlations may be made from features such as pitch, sound intensity, intonation of the spoken word, and the speed of speech of the word. A mathematical model (neural network) for obtaining the degree of correlation (magnitude of emotion) with the tag of emotion may be generated and stored in the storage unit. Furthermore, a control unit of the motor vehicle or the automated driving system may be configured to input the feature amount of the voice data of the conversation into the mathematical model and obtain the type and magnitude of the emotion.

According to various aspects of the present disclosure, the indicator and/or the automatically adapting of the speed is configurable by the at least one vehicle occupant. For example, the duration of the conversation of the at least one vehicle occupant as a trigger for detecting the conversation may be adjusted by the at least one vehicle occupant. Furthermore, the speed change i.e., the magnitude of decrease or increase in speed may be adjusted by the at least one vehicle occupant. Alternatively or additionally, a maximum for the acceleration may be adjusted by the at least one vehicle occupant. Moreover, a minimum speed from which on an adaption, in particular a reduction, of the speed may be carried out may be adjusted by the at least one vehicle occupant. Furthermore, the at least one vehicle occupant may be able to abort a begun speed decrease e.g., by pressing a button of audio-video-navigation system of the motor vehicle.

According to various aspects of the present disclosure, the automatically adapting of the speed is not carried out when the indicator is not triggered. For example, when the conversation is strongly reduced, the automated driving system may switch back to a normal target speed and/or acceleration without being automatically adapted depending on the indicator.

### BRIEF DESCRIPTION OF THE DRAWINGS

The accompanying drawings are included to provide a further understanding of the present disclosure and are incorporated in and constitute a portion of the present specification. The drawings illustrate the exemplary embodiments of the present disclosure and together with the description serve to explain the principles of the present disclosure. Other embodiments of the present disclosure and many of the intended advantages of the present disclosure will be readily appreciated as they become better understood by reference to the following detailed description. The elements of the drawings are not necessarily to scale relative to each other. In the figures, like reference numerals denote like or functionally like components, unless indicated otherwise.

FIG. 1 schematically depicts a system for automatically adapting a speed of a motor vehicle which is operated by an automated driving system according to an exemplary embodiment of the present disclosure.

FIG. 2 shows a flow diagram of a method for automatically adapting a speed of a motor vehicle which is operated by an automated driving system according to another exemplary embodiment of the present disclosure.

FIG. 3 shows a flow diagram of the method step detecting a conversation of FIG. 2 according to another exemplary embodiment of the present disclosure.

Although specific embodiments are illustrated and described herein, it will be appreciated by the those of ordinary skill in the art that a variety of alternate and/or equivalent implementation may be substituted for the specific embodiments shown and described without departing from the scope of the present disclosure. Generally, the present application is directed to cover any adaptations or variations of the specific embodiments discussed herein.

### DETAILED DESCRIPTION

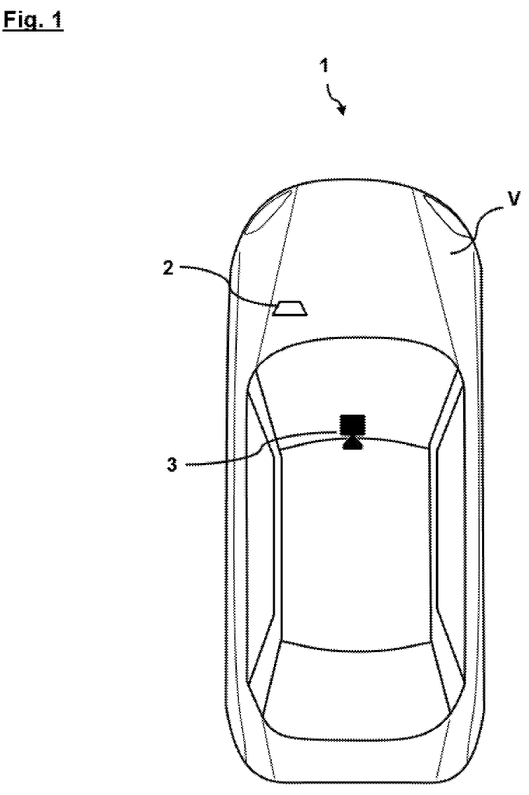

FIG. 1 schematically depicts a system 1 for automatically adapting a speed of a motor vehicle V which is operated by an automated driving system 2 according to an exemplary embodiment of the present disclosure. FIG. 1 shows a motor vehicle V with the system 1.

The system 1 includes an automated driving system 2, which is configured to control a speed of a motor vehicle V, wherein at least one vehicle occupant sits in the motor vehicle V.

The system 1 further includes a microphone unit which is configured to detect a conversation inside the motor vehicle V based on an indicator for the conversation. The indicator includes a voice of the at least one vehicle occupant. The automated driving system 2 is further configured to automatically adapt a speed of the motor vehicle V depending on the indicator for the conversation.

For example, the automated driving system 2 can further be configured to limit an acceleration of the motor vehicle V. Hence, a noise generated by the propulsion system of the motor vehicle V may be reduced during an acceleration process of the motor vehicle. The noise may be reduced when the propulsion system is configured as an internal combustion engine. The acceleration may be limited to a range below about 2 m/s² or less.

Optionally, the system 1 can further include a seat occupancy detection device which is configured to detect a presence of at least another vehicle occupant. For example, the indicator may be triggered by the seat occupancy detection device when at least another vehicle occupant is present in a second seat row or in a third seat row or in both.

Optionally, the system 1 can further include a camera unit 3 which is configured to detect a presence of at least another vehicle occupant. Hence, the camera unit 3 can determine where the at least another vehicle occupant sits in the motor vehicle V and/or who in the motor vehicle V is talking. Furthermore, the camera unit 3 may be configured to determine a facial feature of the at least one vehicle occupant. Thus, an emotion analysis of the conversation may be carried out by the camera unit 3, wherein the emotion analysis is based on the facial feature of the at least one vehicle occupant.

Optionally, the system 1 can further include a speech recognition device which is configured to detect a frequency of asking back between the at least one vehicle occupant. The speech recognition device can further be configured to detect the conversation of at least two vehicle occupants that are talking and sitting in different seat rows with respect to each other.

Optionally, the system 1 can further include an audio-video-navigation system which is configured to adjust a duration of the conversation, a speed change, a maximum for the acceleration and/or a minimum speed. The duration of the conversation of the at least one vehicle occupant as a trigger for detecting the conversation may be adjusted by the at least one vehicle occupant. Furthermore, the speed change, i.e., the magnitude of decrease or increase in speed may be adjusted by the at least one vehicle occupant. Alternatively or additionally, the maximum for the acceleration may be adjusted by the at least one vehicle occupant. Moreover, the minimum speed from which on an adaption, in particular a reduction, of the speed may be carried out may be adjusted by the at least one vehicle occupant. Nevertheless, the minimum speed, or the threshold may be set by traffic rules and/or user settings. Furthermore, the at least one vehicle occupant might be able to abort a begun speed decrease e.g., by pressing a button of audio-video-navigation (AVN) system of the motor vehicle V.

Optionally, the system 1 may further include a non-transitory computer-readable storage medium that is in communication with the automated driving system 2, wherein the storage medium is configured to store a reference value for a volume of the voice of the at least one vehicle occupant, for a facial feature of the at least one vehicle occupant, for a heartrate variability and/or for a skin conductance of the at least one vehicle occupant.

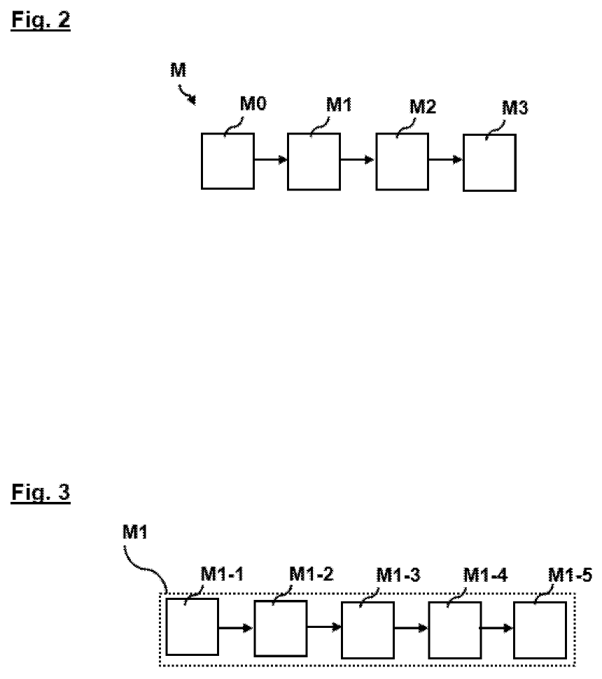

FIG. 2 shows a flow diagram of a method M for automatically adapting a speed of a motor vehicle V which is operated by an automated driving system 2 according to another exemplary embodiment of the present disclosure.

The method M exemplarily includes the steps of operating a motor vehicle V in step M0, detecting a conversation inside the motor vehicle V in step M1, automatically adapting a speed of the motor vehicle V in step M2 and detecting a volume of the conversation in step M0 after the automatically adapting of the speed in step M2.

In the step M0, the motor vehicle V is operated by an automated driving system 2, which is configured to control a speed of the motor vehicle V, wherein at least one vehicle occupant sits in the motor vehicle V.

For example, the conversation may include conversation between at least two vehicle occupants that are talking and sitting in different seat rows with respect to each other.

In the step M1, the conversation is detected inside the motor vehicle V based on an indicator for the conversation, wherein the indicator includes a voice of the at least one vehicle occupant. If the indicator is triggered the conversation is detected. If the conversation is detected the step M2 of automatically adapting the speed is carried out.

The indicator may include a presence of at least another vehicle occupant, a volume of the voice of the at least one vehicle occupant, a facial feature of the at least one vehicle occupant, a duration of the conversation of the at least one vehicle occupant and/or a frequency of asking back between the at least one vehicle occupant. For example, the indicator may be triggered when at least another vehicle occupant is present in a second seat row or in a third seat row or in both. The frequency of asking back may be detected by a speech recognition device which is disposed in the motor vehicle.

The duration of the conversation can exceed a value in the range from about 1 minute to about 3 minutes. Alternatively or additionally, the duration of the conversation can exceed a predetermined quotient of speech and pause.

Moreover, the indicator may further include an emotion analysis of the conversation, wherein the emotion analysis is based on a feature amount of the voice, on facial feature of the at least one vehicle occupant, on a heartrate variability and/or on a skin conductance of the at least one vehicle occupant. In other words, the indicator can further determine an arousal level of the conversation. If the emotion analysis reveals that the at least one vehicle occupant includes a high arousal level, in particular a higher arousal level than usually, it may be assumed that this is the reason for speaking loud and not a high interior noise level. For example, a voice acquisition unit can obtain voice data from the at least one vehicle occupant who talks.

In the step M2, the speed of the motor vehicle V is automatically adapted by the automated driving system 2 depending on the indicator for the conversation.

For example, in the step M2, the speed may be adapted corresponding to a predetermined range of a speed change, to a predetermined range of a percentage value and/or to a reduction of an interior noise in the motor vehicle. For example, the predetermined range of the speed change may be of about 20 km/h or less, in particular in the range from about 5 km/h to about 20 km/h. For example, the predetermined range of the percentage value may be in the range from about 10 % to about 20 %. The reduction of the interior noise could be in the range from about 3 dB to about 8 dB. For example, the interior noise in the motor vehicle may be reduced by increasing the speed so that a stimulating frequency has a greater distance with regard to the eigenfrequency of the motor vehicle.

Alternatively or additionally, the interior noise in the motor vehicle may be reduced by increasing the speed and selecting a higher gear so that a resulting engine speed is lower. In both before mentioned cases, the speed may be increased slightly, in particular up to a speed change of about 10 km/h or less. The percentage value can incorporate environmental conditions, for example a current road class, weather conditions, or similar. Optionally, a change of driving lane may lead to a reduction of the interior noise depending on the road surface. Thus, if permitted by driving rules, the motor vehicle can change the driving lane. If the interior noise is lower than on the original driving lane, the motor vehicle may stay on the new driving lane.

The automatically adapting of the speed in M2 may include limiting an acceleration of the motor vehicle V. Hence, a noise generated by the propulsion system of the motor vehicle V may be reduced during an acceleration process of the motor vehicle. The noise may be reduced when the propulsion system is configured as an internal combustion engine. The acceleration may be limited to a range below about 2 m/s² or less.

The step M2 of automatically adapting the speed is not carried out when the indicator is not triggered. For example, when the conversation is strongly reduced, the automated driving system may switch back to a normal target speed and/or acceleration without being automatically adapted depending on the indicator. That means, if the step M1 is not sufficient or not fulfilled, the speed is not automatically adapted in M2.

In the optional step M3, a volume of the conversation is detected after the automatically adapting of the speed in M2, wherein the volume of the conversation after the automatically adapting of the speed in M2 is compared to a volume of the conversation before the automatically adapting of the speed in M2. Based on the comparison of both the volumes the automatically adapting of the speed in M2 is repeated. Accordingly, the automatically adapting of the speed in M2 does not have to be repeated identically, but it can also adapt the speed in a different way than before. After adapting the speed in M2, it may be detected if the volume of the conversation, so of the at least one speaking vehicle occupant, is reduced or not in M3. In case that a reduction of the volume of the at least one speaking vehicle occupant is deemed as being not sufficient, a further step of automatically adapting the speed, in particular a further reduction of the speed, may be carried out.

Optionally, a signal to noise ratio (SNR) calculation may be performed for detecting if the interior noise is the reason for speaking loud. If a difference in the volume between the conversation volume and the interior noise stays unchanged even if the interior noise level decreases, e.g., due to the lower speed, it may be assumed that the vehicle occupant who talks wants to speak loud.

For example, the indicator and/or the automatically adapting of the speed in M2 may be configurable by the at least one vehicle occupant. For example, the duration of the conversation of the at least one vehicle occupant as a trigger for detecting the conversation may be adjusted by the at least one vehicle occupant. Furthermore, the speed change i.e., the magnitude of decrease or increase in speed may be adjusted by the at least one vehicle occupant. Alternatively or additionally, a maximum for the acceleration may be adjusted by the at least one vehicle occupant. Moreover, a minimum speed from which on an adaption, in particular a reduction, of the speed may be carried out may be adjusted by the at least one vehicle occupant. Furthermore, the at least one vehicle occupant might be able to abort a begun speed decrease e.g., by pressing a button of audio-video-navigation system of the motor vehicle.

FIG. 3 shows a flow diagram of the method step M1 of detecting a conversation of FIG. 2 according to another exemplary embodiment of the present disclosure. The method step M1 can also be useful to determine if there is a benefit of reducing the speed.

The conversation might be ongoing when a voice i.e., a sound may be detected i.e., captured in a passenger compartment of the motor vehicle in Step M1-1.

Optionally, background noise may be filtered in Step M1-2.

Furthermore, the interior noise, in particular the filtered portion of the interior noise, may be classified for differing between a human voice and other voice types in Step M1-3.

The indicator can further determine i.e., check if the detected speech, in particular the human voice, in the conversation corresponds to a radio broadcast content in Step M1-4. In case that the detected speech includes the radio broadcast content the indicator is not triggered. Thus, the conversation is not detected when the detected speech includes the radio broadcast content.

Additionally, a volume of voice over time may be determined for triggering the indicator or not in Step M1-5.

All the method steps M0, M1, M1-1, M1-2, M1-3, M1-4, M2, and M3 as described above may be carried out in the sequence as described or illustrated, but the sequence is not limited to these examples.

In the foregoing detailed description, various features are grouped together in one or more examples for streamlining the present disclosure. It is to be understood that the above description is intended to be illustrative, and not restrictive. It is intended to cover all alternatives, modifications and equivalents of the different features and embodiments. Many other examples will be apparent to one skilled in the art upon reviewing the above specification. The exemplary embodiments were chosen and described to explain the principles of the present disclosure and its practical applications, to thereby enable others skilled in the art to utilize the present disclosure and various embodiments with various modifications as are suited to the particular use contemplated.

### REFERENCE LIST

1 system
2 automated driving system
3 camera unit
V motor vehicle
M method
M0 operating a motor vehicle
M1 detecting a conversation inside the motor vehicle
M1-1 capturing of sound
M1-2 filtering for background noise
M1-3 classifying of sound
M1-4 checking the source of voice
M1-5 determining the volume of the voice over time
M2 automatically adapting a speed of the motor vehicle
M3 detecting a volume of the conversation after the automatically adapting of the speed

What is claimed is:

1. A system for automatically adapting a speed of a vehicle which is operated by an automated driving system, the system comprising:
the automated driving system controlling the speed of the vehicle, wherein at least one vehicle occupant sits in the vehicle; and
a microphone unit detecting a conversation inside the vehicle based on an indicator for the conversation, wherein the indicator includes a voice of the at least one vehicle occupant,
wherein the automated driving system automatically adapts the speed of the vehicle depending on the indicator for the conversation.

2. The system of claim 1, further comprising a seat occupancy detection device detecting a presence of at least another vehicle occupant.

3. The system of claim 1, further comprising a camera unit detecting a presence of the at least another vehicle occupant.

4. The system of the claim 1, further comprising a speech recognition device detecting a frequency of asking back between vehicle occupants.

5. The system of the claim 1, wherein the automated driving system is further configured to limit an acceleration of the vehicle.

6. The system of the claim 1, further comprising an audio-video-navigation system adjusting a duration of the conversation, a speed change, a maximum for the acceleration and/or a minimum speed.

7. The system of claim 1, wherein the indicator includes a presence of at least another vehicle occupant, a volume of the voice of the at least one vehicle occupant, a facial feature of the at least one vehicle occupant, a duration of the conversation of the at least one vehicle occupant and/or a frequency of asking back between vehicle occupants.

8. The system of claim 1, wherein the automated driving system adopts the speed of the vehicle to correspond to a predetermined range of a speed change, to a predetermined range of a percentage value and/or to a reduction of an interior noise in the vehicle.

9. A vehicle comprising the system of claim 1.

10. A method for automatically adapting the speed of the vehicle which is operated by the automated driving system, by use of the system of claim 1, the method comprising the steps of:
operating the vehicle, by the automated driving system controlling the speed of the vehicle, wherein the at least one vehicle occupant sits in the vehicle;
detecting the conversation inside the vehicle based on the indicator for the conversation, wherein the indicator includes the voice of the at least one vehicle occupant; and
automatically adapting the speed of the vehicle, by the automated driving system depending on the indicator for the conversation.

11. The method of claim 10, wherein the speed is adapted corresponding to a predetermined range of a speed change, to a predetermined range of a percentage value and/or to a reduction of an interior noise in the vehicle.

12. The method of claim 10, wherein the indicator includes a presence of at least another vehicle occupant, a volume of the voice of the at least one vehicle occupant, a facial feature of the at least one vehicle occupant, a duration of the conversation of the at least one vehicle occupant and/or a frequency of asking back between vehicle occupants.

13. The method of claim 12, wherein the duration of the conversation exceeds a value in a range from about 1 minute to about 3 minutes.

14. The method of the claim 10, wherein the conversation includes a conversation between at least two vehicle occupants that are talking and sitting in different seat rows with respect to each other.

15. The method of the claim 10, wherein the indicator is further configured to determine whether a detected speech in the conversation corresponds to a radio broadcast content.

16. The method of the claim 10, wherein the automatically adapting of the speed includes limiting an acceleration of the vehicle.

17. The method of the claim 10, further comprising:
detecting a volume of the conversation after the automatically adapting of the speed,
wherein the volume of the conversation after the automatically adapting of the speed is compared to a volume of the conversation before the automatically adapting of the speed, and
wherein based on the comparison of the volumes of the conversation after the automatically adapting of the speed and the conversation before the automatically adapting of the speed, the automatically adapting of the speed is repeated.

18. The method of the claim 10,
wherein the indicator further includes an emotion analysis of the conversation, and
wherein the emotion analysis is based on a feature amount of the voice, on facial feature of the at least one vehicle occupant, on a heartrate variability and/or on a skin conductance of the at least one vehicle occupant.

19. The method of the claim 10, wherein the indicator and/or the automatically adapting of the speed is configurable by the at least one vehicle occupant.

20. The method of claim 10, wherein the automatically adapting of the speed is not carried out based on that the indicator is not triggered.
